(19) United States
(12) Patent Application Publication
(10) Pub. No.: US 2025/0320239 A1
(43) Pub. Date: Oct. 16, 2025

(54) A PROCESS FOR PREPARING A LIQUID FORMULATION

(71) Applicant: UPL LIMITED, Mumbai (IN)

(72) Inventors: Achintya Laxman MONDAL, Mumbai (IN); Satish Ekanath BHOGE, Mumbai (IN); Vikas Vinayak OLTIKAR, Mumbai (IN)

(21) Appl. No.: 18/869,876

(22) PCT Filed: May 31, 2023
(86) PCT No.: PCT/IB2023/055552

§ 371 Date: Nov. 27, 2024

(30) Foreign Application Priority Data
May 31, 2022 (IN) 202221031168

(51) Int. Cl. C07F 9/30; A01N 57/20; A01P 13/00

(52) U.S. Cl. CPC C07F 9/301; A01N 57/20; A01P 13/00

(57) ABSTRACT

The present invention relates to a process for preparing a liquid formulation of an ammonium salt of glufosinate, or isomers thereof, from corresponding glufosinate. More particularly, the present invention relates to a process for preparing a liquid formulation of an ammonium salt of L-glufosinate and a method of using the same thereof.

### FIELD OF THE INVENTION

The present invention relates to a process for preparing a liquid formulation of an ammonium salt of glufosinate, or isomers thereof. The present invention also provides a method of controlling weeds using the prepared formulation.

### BACKGROUND OF THE INVENTION

Glufosinate is a non-selective herbicide, belonging to the group of organophosphorous herbicides, which is widely used around the world. It is generally used in the form of an ammonium salt for unwanted vegetation control and to control growth of weeds and grasses. Glufosinate contains an asymmetric carbon atom, and its biological activity is seen in racemic mixture (of L-glufosinate and D-glufosinate) and L-glufosinate enantiomer. The ammonium salt of these compounds (both L-glufosinate enantiomer and racemic mixture) is particularly important. The ammonium salts of glufosinate and L-glufosinate are preferably formulated as aqueous solutions.

U.S. Pat. No. 5,491,125 discloses a liquid herbicidal agent comprising glufosinate ammonium salt in combination with various surfactants. The agent is prepared by dissolving glufosinate ammonium or L-glufosinate ammonium in water followed by adding action-enhancing surface-active agent (surfactants) and customary auxiliaries such as solubilizers, colorants or defoamers and the batch is mixed to get the final product.

The process provided in the prior art involves use of glufosinate salt for the preparation of the desired formulation. The conversion of glufosinate-to-glufosinate salt is an essential step required for preparation of such formulation.

There is a worldwide drive to reduce the cost of pesticides applied on the field so as not to increase the cost of food. This can be done by reducing overall cost for production of formulation. Such objective can also be met by reducing the overall productions steps, as reduced numbers of steps shall save energy, manpower and loss of active ingredients in transfer/isolation of product and so on.

Another problem encountered by inventors of the present invention was that the ammonium salt of glufosinate was readily soluble in water, however the same was not true for ammonium salt of L-glufosinate. The inventors of the present invention noticed that ammonium salt of L-glufosinate when in contact with water forms a rock-solid lump, which has low solubility. This rock-solid lump formation makes the process for producing a homogenous composition difficult and cumbersome.

Therefore, the process of the present invention overcomes all the above stated limitations, solves one or more aforementioned problems, and provides a simple, economic and environment-friendly process for preparing a liquid formulation of an ammonium salt of glufosinate, or isomers thereof.

### OBJECTIVE OF THE INVENTION

Accordingly, it is a primary objective of the present invention to provide a process for preparing a liquid formulation of an ammonium salt of glufosinate, or isomers thereof.

It is another objective of the present invention to provide a low cost and an efficient process for preparing a liquid formulation of an ammonium salt of glufosinate, or isomers thereof, from corresponding glufosinate.

It is yet another objective of the present invention to provide an industrially viable, reproducible and simple process for preparing a liquid formulation of an ammonium salt of glufosinate, or isomers thereof from corresponding glufosinate.

It is yet objective of the present invention to provide a process for preparing a liquid formulation of an ammonium salt of L-glufosinate, or isomers thereof.

### SUMMARY OF THE INVENTION

According to an aspect of the present invention, there is provided a process for preparing a liquid formulation of an ammonium salt of glufosinate, or isomers thereof from corresponding glufosinate.

According to an aspect of the present invention, there is provided a process for preparing a liquid formulation of an ammonium salt of glufosinate, or isomers thereof, said process comprising in-situ salification of glufosinate.

According to an aspect of the present invention, there is provided a process for preparing a liquid formulation of an ammonium salt of glufosinate, or isomers thereof, said process comprising in-situ salification of glufosinate with ammonia.

According to an aspect of the present invention, there is provided a process for preparing a liquid formulation of an ammonium salt of L-glufosinate, or isomers thereof, said process comprising a step of in-situ salification of L-glufosinate with ammonia.

### DESCRIPTION OF THE INVENTION

Those skilled in art will be aware that the invention described herein is subject to variations and modifications other than those specifically described. It is to be understood that the invention described herein includes all such variations and modifications. The invention also includes all such steps, features, compositions and processes referred to or indicated in this specification, individually or collectively, and any and all combinations of any two or more said steps or features.

For convenience, before further description of the present invention, certain terms employed in the specification, examples are described here. These definitions should be read in light of the remainder of the disclosure and understood as by a person of skill in the art. Unless defined otherwise, all technical and scientific terms used herein have the same meaning as commonly understood by a person of ordinary skill in the art. The terms used throughout this specification are defined as follows, unless otherwise limited in specific instances.

The terms used herein are defined as follows.

It must be noted that, as used in this specification, the singular forms “a”, “an”, and “the” include plural referents unless the content clearly dictates otherwise. The terms “preferred” and “preferably” refer to embodiments of the disclosure that may afford certain benefits, under certain circumstances.

As used herein, the terms “comprising”, “including”, “having”, “containing”, “involving”, and the like are to be understood to be open-ended i.e., to mean including but not limited to.

As used herein, the terms “about” or “approximately” are inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±10 or ±5 of the stated value.

The use of any and all examples, or exemplary language (e.g., “such as”), is intended merely to better illustrate the disclosure and does not pose a limitation on the scope of the disclosure unless otherwise claimed. No language in the specification should be construed as indicating any non-claimed element as essential to the practice of the disclosure as used herein.

While the disclosure has been described with reference to an exemplary embodiment, it will be understood by those skilled in the art that various changes may be made, and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure is not limited to the particular embodiment disclosed as the best mode contemplated for carrying out this disclosure, but that the disclosure will include all embodiments falling within the scope of the appended claims.

As used herein, the term “herbicide” encompasses both herbicides as well as plant growth regulators, in so far as this does not otherwise emerge from the context.

As used herein, the term “herbicidally effective amount” is an amount of active ingredient such as a herbicide which causes an adversely modifying effect and includes deviations from natural development, killing, regulation, desiccation, retardation, and the like.

As used herein, the term “plant” or “crop” refers to whole plants, plant organs (e.g., leaves, stems, twigs, roots, trunks, limbs, shoots, fruits etc.), plant cells, or plant seeds. This term also encompasses plant crops such as fruits. The term “plant” may further include the propagation material thereof, which may include all the generative parts of the plant such as seeds and vegetative plant material such as cuttings and tubers, which can be used for the multiplication of the plant. This includes seeds, tubers, spores, corms, bulbs, rhizomes, sprouts basal shoots, stolons, and buds and other parts of plants, including seedlings and young plants, which are to be transplanted after germination or after emergence from soil.

As used herein, the term “locus” as used herein shall denote the vicinity of a desired crop in which control of weed is desired. The locus includes the vicinity of desired crop plants wherein the growth of weed has either emerged or is most likely to emerge or is yet to emerge.

As used herein, the term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes, parts of plants. Germinated plants or young plants, which may be transplanted after germination or after emergence from the soil. As used herein, the term “seed” embraces seeds and plant propagules of all kinds including but not limited to true seeds, seed pieces, suckers, corms, bulbs, fruit, tubers, grains, cuttings, cut shoots and the like and means in a preferred embodiment true seed.

As used herein the term “composition” is used interchangeably with the term “formulation”.

The term “liquid formulation” unless stated otherwise, includes all aqueous based liquid formulations such as soluble liquid, emulsion in water, microemulsion, emulsifiable concentrate, suspension concentrates, and so on.

The term “room temperature” unless stated otherwise, essentially means temperature in a range from about 20° C. to about 45° C.

The term “salification” unless stated otherwise, essentially means “to convert an active substance into a salt”. The term “salification” is used interchangeably with the term “neutralisation”.

The term “liquid medium” unless stated otherwise, essentially means a slurry/dispersion wherein distributed particles of active ingredient are dispersed in a continuous phase of another material; or a solution wherein active ingredient is dissolved in a continuous phase of another material. The term “dispersion” is used interchangeably with the term “slurry” or “suspension”.

As used herein, the term “glufosinate” comprises glufosinate acid, L-glufosinate, D-glufosinate, or isomers thereof. The terms may be used interchangeably. The term “L-glufosinate” is used interchangeably with the term “glufosinate P”. The terms “L-glufosinate acid” and “Glufosinate P acid” are used interchangeably.

According to an aspect of the present invention, there is provided a process for preparing a liquid formulation of an ammonium salt of glufosinate, or isomers thereof.

According to an aspect of the present invention, there is provided a process for preparing a liquid formulation of an ammonium salt of glufosinate, or isomers thereof from corresponding glufosinate.

According to an aspect of the present invention, there is provided a process for preparing a liquid formulation of an ammonium salt of glufosinate, or isomers thereof, said process comprising in-situ salification of glufosinate.

According to an embodiment, the glufosinate is selected from the group comprising racemic glufosinate, L-glufosinate, D-glufosinate, a racemic mixture of L-glufosinate and D-glufosinate, isomers, or combinations thereof.

According to an embodiment, the glufosinate comprises a racemic mixture of L-glufosinate and D-glufosinate.

According to an embodiment, the glufosinate comprises L-glufosinate.

According to an aspect of the present invention, there is provided a process for preparing a liquid formulation of an ammonium salt of L-glufosinate, or isomers thereof, said process comprising in-situ salification of L-glufosinate.

According to an embodiment, the glufosinate comprises a racemic mixture of D-enantiomer (about 50%) and L-enantiomer (about 50%).

In an embodiment, the glufosinate comprises a racemic mixture of D-glufosinate (about 50%) and L-glufosinate (about 50%).

According to an embodiment, the glufosinate comprises L-glufosinate in enantio-enriched form (more than about 50% L-glufosinate) or enantio-pure form (about 100% L-glufosinate).

According to an embodiment, the glufosinate comprises at least 80% L-glufosinate and not more than 20% D-glufosinate.

According to an embodiment, the glufosinate comprises at least 90% L-glufosinate and not more than 10% D-glufosinate.

According to an embodiment, the glufosinate comprises at least 95% L-glufosinate and not more than 5% D-glufosinate.

According to an embodiment, the glufosinate comprises a weight ratio of L-isomer to D-isomer in a range from about 1:99 to about 99:1.

In an embodiment, the glufosinate comprises a weight ratio of L-glufosinate to D-glufosinate in a range from about 1:99 to about 99:1.

According to an embodiment, the glufosinate is selected from the group comprising racemic glufosinate, L-glufosinate, D-glufosinate, a racemic mixture of L-glufosinate and D-glufosinate, isomers, or combinations thereof, wherein a weight ratio of L-isomer to D-isomer is in a range from about 1:99 to about 99:1.

In an embodiment, the glufosinate is selected from the group comprising racemic glufosinate, L-glufosinate, D-glufosinate, a racemic mixture of L-glufosinate and D-glufosinate, isomers, or combinations thereof, wherein a weight ratio of L-glufosinate to D-glufosinate is in a range from about 1:99 to about 99:1.

According to an embodiment, a process for preparing a liquid formulation of an ammonium salt of glufosinate, or isomers thereof, said process comprising reacting glufosinate, suspended in a liquid medium, with ammonia.

According to an embodiment, a process for preparing a liquid formulation of an ammonium salt of glufosinate, or isomers thereof, said process comprising reacting a dispersion comprising glufosinate, suspended in a liquid medium, with ammonia.

In an embodiment, the glufosinate is L-glufosinate.

According to an embodiment, a process for preparing a liquid formulation of an ammonium salt of glufosinate, or isomers thereof, said process comprising reacting glufosinate, suspended in a liquid medium, with ammonia; and adding at least one surfactant or at least one adjuvant.

According to an embodiment, there is provided a process for preparing a liquid formulation of an ammonium salt of glufosinate, or isomers thereof, said process comprising:
a) suspending glufosinate in a liquid medium to obtain a dispersion; and
b) salifying the dispersion of step a) with ammonia to obtain the liquid formulation of ammonium salt of glufosinate.

According to an embodiment, the suspended glufosinate obtained in step a) is in a form of a slurry, or a dispersion, or combinations thereof.

According to an embodiment, the liquid medium in step a) is selected from the group comprising water, an organic solvent, a surfactant, or combinations thereof.

According to an embodiment, the liquid medium in step a) is selected from the group comprising water, an organic solvent, a liquid surfactant, or combinations thereof.

According to an embodiment, the liquid medium in step a) comprises water.

According to an embodiment, the liquid medium in step a) comprises water; and the liquid medium further comprises a surfactant.

According to an embodiment, the liquid medium in step a) comprises water; and the liquid medium further comprises a liquid surfactant.

According to an embodiment, the liquid medium in step a) comprises water; and the liquid medium further comprises a water-soluble surfactant.

According to an embodiment, the liquid medium comprises a water-soluble surfactant.

According to an embodiment, the water-soluble surfactant is selected from the group comprising alkyl glucamide, alkyl polyglucoside, alkyl amine oxide, or combinations thereof.

According to an embodiment, the liquid medium in step a) comprises water; and the liquid medium further comprises an organic solvent.

According to an embodiment, the liquid medium in step a) comprises an organic solvent.

According to an embodiment, the organic solvent may be selected from the group comprising a water miscible polar/non-polar solvent or a water immiscible polar/non-polar solvent. The organic solvent is selected from the group comprising alkyl esters of phthalic acid and trimellitic acid; aromatic hydrocarbons such as xylene, high solvency C₉ aromatic fluid, high solvency C₁₀ aromatic fluid, high solvency C₁₁ aromatic fluid, alkyl benzenes; methylnaphthalene; mixtures of aromatics aliphatic or cycloaliphatic hydrocarbon such as hexanes and heptanes; phthalates; ketones such as cyclohexanone, 2-octanone or acetophenone, methyl isobutyl ketone; saturated or unsaturated cyclic ketones such as isophorone; chlorinated hydrocarbons; vegetable oils and modified vegetable oils; glycols and their derivatives; aliphatic alcohols; alkoxy aliphatic alcohols; mixtures of such two or more solvents, or combinations thereof.

According to an embodiment, other solvents can be selected from the group comprising alkylene carbonates (like propylene carbonate), alkyl amides, and esters such as alkyl esters of monocarboxylic acids and dicarboxylic acid, esteramides, cyclic ethers such furan, and its derivatives, or combinations thereof.

In a preferred embodiment, the organic solvent is selected from the group comprising vegetable oils and modified vegetable oils, glycols and their derivatives, esters, or combinations thereof.

According to an embodiment, the organic solvent is selected from the group comprising vegetable oils such as castor oil and modified vegetable oils; glycols and their derivatives such as propylene glycol, dipropylene glycol, polypropylene glycol, monoethylene glycol, diethylene glycol, polyethlene glycol 300 1-methoxy-2-propanol, butoxy ethanol; and esters such as methyl ester of C₈-C₂₀ fatty acids; or combinations thereof.

According to an embodiment, the organic solvent comprises glycols and their derivatives selected from the group comprising propylene glycol, dipropylene glycol, polypropylene glycol, monoethylene glycol, diethylene glycol, polyethlene glycol 300, 1-methoxy-2-propanol, butoxy ethanol, or combinations thereof.

In a preferred embodiment, the organic solvent comprises propylene glycol.

In a preferred embodiment, the organic solvent comprises butoxy ethanol.

According to a preferred embodiment, the organic solvent comprises propylene glycol and butoxy ethanol.

According to another preferred embodiment, the organic solvent comprises a mixture of propylene glycol and butoxy ethanol.

In another preferred embodiment, the organic solvent comprises a combination of propylene glycol and butoxy ethanol.

According to an embodiment, the organic solvent comprises propylene glycol and butoxy ethanol in a weight ratio from about 1:9 to about 9:1.

According to another embodiment, the organic solvent comprises propylene glycol and butoxy ethanol in a weight ratio from about 1:1 to about 5:1.

According to another embodiment, the organic solvent comprises propylene glycol and butoxy ethanol in a weight ratio of about 1:1.

According to another embodiment, the organic solvent comprises propylene glycol and butoxy ethanol in a weight ratio of about 2:1.

According to another embodiment, the organic solvent comprises propylene glycol and butoxy ethanol in a weight ratio of about 3:1.

According to another embodiment, the organic solvent comprises propylene glycol and butoxy ethanol in a weight ratio of about 4:1.

According to another embodiment, the organic solvent comprises propylene glycol and butoxy ethanol in a weight ratio of about 5:1.

According to an embodiment, the liquid medium comprises water and an organic solvent.

According to an embodiment, the liquid medium comprises water, and propylene glycol and butoxy ethanol.

According to an embodiment, the liquid medium comprises water and a mixture of propylene glycol and butoxy ethanol.

According to an embodiment, the liquid medium comprises water and a combination of propylene glycol and butoxy ethanol.

According to an embodiment, the liquid medium comprises water and the organic solvent comprising propylene glycol and butoxy ethanol in a weight ratio from about 1:9 to about 9:1.

According to an embodiment, the liquid medium comprises water and the organic solvent comprising a mixture of propylene glycol and butoxy ethanol in a weight ratio from about 1:9 to about 9:1.

According to an embodiment, the liquid medium in step a) further comprises a surfactant.

According to an embodiment, the surfactant is selected from the group comprising anionic surfactants, cationic surfactants, zwitterionic surfactants, non-ionic surfactants, or combinations thereof.

According to an embodiment, the surfactant is selected from the group comprising alcohol ethoxylate, alkyl ether phosphate, alkyl aryl ether phosphate, sulfosuccinate and its derivatives, or combinations thereof.

According to an embodiment, the liquid medium comprises an organic solvent and a surfactant.

According to an embodiment, the liquid medium comprises an organic solvent and a liquid surfactant.

According to an embodiment, the liquid medium comprises water, an organic solvent and a surfactant.

According to an embodiment, the liquid medium comprises water, an organic solvent and a liquid surfactant.

According to an embodiment, step b) of the process comprises salifying the dispersion of step a) with ammonia.

According to an embodiment, step b) of the process comprises salifying glufosinate with ammonia.

According to an embodiment, step b) comprises heating the dispersion comprising glufosinate in a liquid medium at a temperature range from about 40° C. to about 100° C., and salifying the dispersion comprising glufosinate using ammonia.

According to an embodiment, step b) comprises heating the dispersion comprising glufosinate in a liquid medium at a temperature range from about 40° C. to about 100° C., and salifying the glufosinate using ammonia.

According to an embodiment, step b) comprises heating the dispersion comprising glufosinate in a liquid medium at a temperature range from about 40° C. to about 100° C., and salifying the dispersion using ammonia.

According to an embodiment, the liquid medium comprising glufosinate is heated to a temperature in a range from about 40° C. to about 100° C. and salified using ammonia.

According to an embodiment, the ammonia used for salification of the dispersion, comprising glufosinate in a liquid medium in step b) is gaseous ammonia.

According to an embodiment, the ammonia is added to the dispersion of step a) to adjust the pH value in a range from about 6 to about 9.

According to an embodiment, the dispersion after adjustment of pH is stirred from about 30 minutes to about 400 minutes to obtain a liquid formulation of ammonium salt of glufosinate, or isomers thereof.

According to an aspect of the present invention, there is provided a process for preparing a liquid formulation of an ammonium salt of glufosinate, or isomers thereof, said process comprising in-situ salification of glufosinate.

According to an aspect of the present invention, there is provided a process for preparing a liquid formulation of an ammonium salt of glufosinate, said process comprising in-situ salification of glufosinate with ammonia.

According to an aspect of the present invention, there is provided a process for preparing a liquid formulation of an ammonium salt of L-glufosinate, said process comprising in-situ salification of L-glufosinate.

According to an aspect of the present invention, there is provided a process for preparing a liquid formulation of an ammonium salt of L-glufosinate, said process comprising in-situ salification of L-glufosinate with ammonia.

According to an embodiment, there is provided a process for preparing a liquid formulation of an ammonium salt of glufosinate, or isomers thereof, said process comprising:
a) suspending glufosinate in a liquid medium to obtain a dispersion;
b) salifying the dispersion of step a) with ammonia; and
c) subsequently, adding at least one surfactant or at least one adjuvant, or combinations thereof, to step b) to obtain the liquid formulation of ammonium salt of glufosinate.

According to an embodiment, there is provided a process for preparing a liquid formulation of an ammonium salt of L-glufosinate, said process comprising:
a) suspending L-glufosinate in a liquid medium to obtain a dispersion;
b) salifying the dispersion comprising L-glufosinate in liquid medium of step a) with ammonia; and
c) subsequently, adding at least one surfactant or at least one adjuvant, or combinations thereof, to step b) to obtain the liquid formulation of ammonium salt of L-glufosinate.

According to an embodiment, there is provided a process for preparing a liquid formulation of an ammonium salt of L-glufosinate, said process comprising:
a) suspending L-glufosinate in a liquid medium to obtain a dispersion;
b) salifying the dispersion comprising L-glufosinate in liquid medium of step a) with ammonia; and
c) subsequently, adding at least one liquid surfactant or at least one adjuvant, or combinations thereof, to step b) to obtain the liquid formulation of ammonium salt of L-glufosinate.

According to an embodiment, there is provided a process for preparing a liquid formulation of an ammonium salt of glufosinate, or isomers thereof, said process comprising:
a) suspending glufosinate in a liquid medium to obtain a dispersion;
b) adding at least one surfactant or at least one adjuvant, or combinations thereof to the dispersion; and
c) subsequently salifying the dispersion with ammonia to obtain the liquid formulation of ammonium salt of glufosinate.

According to an embodiment, there is provided a process for preparing a liquid formulation of an ammonium salt of L-glufosinate, said process comprising:
a) suspending L-glufosinate in a liquid medium to obtain a dispersion;
b) adding at least one surfactant or at least one adjuvant, or combinations thereof to the dispersion; and
c) subsequently salifying the dispersion with ammonia to obtain the liquid formulation of ammonium salt of L-glufosinate.

According to an embodiment, there is provided a process for preparing a liquid formulation of an ammonium salt of L-glufosinate, said process comprising:
d) suspending L-glufosinate in a liquid medium to obtain a dispersion;
e) adding at least one liquid surfactant or at least one adjuvant, or combinations thereof to the dispersion; and
f) subsequently salifying the dispersion with ammonia to obtain the liquid formulation of ammonium salt of L-glufosinate.

According to an aspect of the present invention, there is provided a process for preparing a liquid formulation of an ammonium salt of L-glufosinate, said process comprising the step of in-situ salification of L-glufosinate with gaseous ammonia.

According to an embodiment, there is provided a process for preparing a liquid formulation of an ammonium salt of glufosinate, or isomers thereof, said process comprising:
a) suspending glufosinate in water to obtain a dispersion; and
b) salifying the dispersion of step a) with ammonia to obtain the liquid formulation of ammonium salt of glufosinate.

According to an embodiment, there is provided a process for preparing a liquid formulation of an ammonium salt of L-glufosinate, said process comprising:
a) suspending L-glufosinate in water to obtain a dispersion; and
b) salifying the dispersion of step a) with ammonia to obtain the liquid formulation of ammonium salt of L-glufosinate.

According to an embodiment, there is provided a process for preparing a liquid formulation of an ammonium salt of glufosinate, or isomers thereof, said process comprising:
a) suspending glufosinate in water to obtain a dispersion;
b) adding at least one surfactant or at least one adjuvant, or combinations thereof to the dispersion; and
c) subsequently salifying the dispersion with ammonia to obtain the liquid formulation of ammonium salt of glufosinate.

According to an embodiment, there is provided a process for preparing a liquid formulation of an ammonium salt of L-glufosinate, said process comprising:
a) suspending L-glufosinate in water to obtain a dispersion;
b) adding at least one liquid surfactant or at least one adjuvant, or combinations thereof to the dispersion; and
c) subsequently salifying the dispersion with ammonia to obtain the liquid formulation of ammonium salt of L-glufosinate.

According to another embodiment, there is provided a liquid formulation of an ammonium salt of glufosinate, or isomers thereof, said formulation comprising:
a) an ammonium salt of glufosinate;
b) at least one organic solvent or at least one surfactant; and
c) water.
wherein said ammonium salt of glufosinate is prepared by in-situ salification of glufosinate.

According to another embodiment, there is provided a liquid formulation of an ammonium salt of L-glufosinate, or isomers thereof, said formulation comprising:
a) an ammonium salt of L-glufosinate;
b) at least one organic solvent or at least one liquid surfactant; and
c) water.
wherein said ammonium salt of L-glufosinate is prepared by in-situ salification of L-glufosinate.

According to an embodiment, the ammonium salt of glufosinate is ammonium salt of racemic glufosinate, L-glufosinate, D-glufosinate, a mixture of L-glufosinate and D-glufosinate, isomers, or combinations thereof, wherein a weight ratio of L-isomer to D-isomer is in a range from about 1:99 to about 99:1.

According to an embodiment, the ammonium salt of glufosinate is ammonium salt of racemic glufosinate, L-glufosinate, D-glufosinate, a mixture of L-glufosinate and D-glufosinate, isomers, or combinations thereof, wherein a weight ratio of L-glufosinate to D-glufosinate is in a range from about 1:99 to about 99:1.

According to an embodiment, the liquid formulation comprises from about 1% w/w to about 95% w/w ammonium salt of glufosinate of total weight of the formulation.

According to an embodiment, the liquid formulation comprises from about 1% w/w to about 75% w/w ammonium salt of glufosinate of total weight of the formulation.

According to an embodiment, the liquid formulation comprises from about 10% w/w to about 75% w/w ammonium salt of glufosinate of total weight of the formulation.

According to an embodiment, the liquid formulation comprises from about 10% w/w to about 50% w/w ammonium salt of glufosinate of total weight of the formulation.

According to an embodiment, the liquid formulation comprises from about 10% w/w to about 50% w/w ammonium salt of L-glufosinate of total weight of the formulation.

According to an embodiment, the liquid formulation comprises from about 0% w/w to about 60% w/w surfactant(s) of total weight of the formulation.

According to an embodiment, the liquid formulation comprises from about 10% w/w to about 50% w/w surfactant(s) of total weight of the formulation.

According to an embodiment, the liquid formulation comprises from about 10% w/w to about 50% w/w liquid surfactant(s) of total weight of the formulation.

According to an embodiment, the liquid formulation comprises from about of 1% w/w about 40% w/w organic solvent(s) of total weight of the formulation.

According to an embodiment, the liquid formulation comprises from about of 1% w/w about 30% w/w organic solvent(s) of total weight of the formulation.

According to an embodiment, the liquid formulation comprises from about of 10% w/w about 30% w/w organic solvent(s) of total weight of the formulation.

According to an embodiment, the liquid formulation may further comprise one or more additional surfactants.

According to another embodiment, the additional surfactants used are selected from the group comprising anionic surfactants, cationic surfactants, zwitterionic surfactants, non-ionic surfactants, or combinations thereof.

According to another embodiment, the examples of anionic surfactants include anionic derivatives of fatty alcohols having 10-24 carbon atoms in the form of ether carboxylates, sulfonates, sulfates, and phosphates, and their inorganic salts (e.g., alkali metal salts and alkaline earth metal salts) and organic salts (e.g., salts based on amine or alkanolamine); anionic derivatives of copolymers consisting of ethylene oxide (EO), propylene oxide (PO) and/or butylene oxide (BO) units, in the form of ether carboxylates, sulfonates, sulfates, and phosphates, and their inorganic salts (e.g., alkali metal salts and alkaline earth metal salts) and organic salts (e.g., salts based on amine or alkanolamine); derivatives of alkylene oxide adducts of alcohols, in the form of ether carboxylates, sulfonates, sulfates and phosphates, and their inorganic salts (e.g., alkali metal salts and alkaline earth metal salts) and organic salts (e.g., salts based on amine or alkanolamine); derivatives of fatty acid alkoxylates, in the form of ether carboxylates, sulfonates, sulfates and phosphates, and their inorganic salts (e.g., alkali metal salts and alkaline earth metal salts) and organic salts (e.g., salts based on amine or alkanolamine); alkyl ether phosphate, alkyl sulfosuccinate mono ester and diester salts, or combinations thereof.

According to another embodiment, the examples of cationic surfactants or zwitterionic surfactants may be selected from alkylene oxide adducts of fatty amines, quaternary ammonium compounds having 8 to 22 carbon atoms (C₈-C₂₂), surface-active zwitterionic compounds such as taurides, betaines and sulfobetaines, or combinations thereof.

According to another embodiment, the examples of non-ionic surfactants are alkylpolyglycosides, alkyl glucamide, alkyl amine oxides having C₈ to C₂₀ carbon atoms, alcohol ethoxylate, fatty acid methyl ester, sorbitan ester and ethoxylated sorbitan ester, ethoxylated alkylphenol, ethoxylated tristyrylphenol and alkyl amide, fatty alcohols having 10-24 carbon atoms with 0-60 EO and/or 0-20 PO and/or 0-15 BO in any order; fatty acid alkoxylates and triglyceride alkoxylates; fatty acid amide alkoxylates; alkylene oxide adducts of alkynediols; sugar derivatives such as amino sugars and amido sugars; polyacrylic and polymethacrylic derivatives; polyamides such as modified gelatins or derivatized polyaspartic acid; surfactant polyvinyl compounds such as modified polyvinylpyrrolidone (PVP); polyol-based alkylene oxide adducts; polyglycerides and derivatives, or combinations thereof.

In a preferred embodiment, the surfactants comprise alkylpolyglycosides, alkyl glucamide, alkyl amine oxides such as alkyl dimethylamine oxide, alcohol ethoxylate, fatty acid methyl ester, sorbitan ester and ethoxylated sorbitan ester, ethoxylated alkylphenol, ethoxylated tristyrylphenol, alkyl amide, alkyl ether phosphate, alkyl ether phosphate ester, alkyl sulfosuccinate mono ester and diester, or combinations thereof.

According to an embodiment, the liquid formulation may further comprise one or more adjuvant(s).

In an embodiment, the adjuvant may be selected from potassium chloride, ammonium sulfate, or combinations thereof.

According to an embodiment, there is provided a liquid formulation of an ammonium salt of L-glufosinate prepared by the process of the present invention, said formulation comprising:
a) an ammonium salt of L-glufosinate;
b) at least one organic solvent or at least one surfactant;
c) water; and
d) at least one agrochemically acceptable excipient.

According to an embodiment, there is provided a liquid formulation of an ammonium salt of L-glufosinate prepared by the process of the present invention, said formulation comprising:
a) an ammonium salt of L-glufosinate;
b) at least one organic solvent or at least one liquid surfactant;
c) water; and
d) at least one agrochemically acceptable excipient.

According to an embodiment, the liquid formulation may further comprise at least one agrochemically acceptable excipients such as surfactant(s), solvent(s), fertilizer(s), pH modifier(s), crystallization inhibitor(s), viscosity modifier(s), suspending agent(s), spray droplet modifier(s), pigment(s), antioxidant(s), foaming agent(s), light-blocking agent(s), compatibilizing agent(s), antifoam agent(s), sequestering agent(s), neutralizing agent(s), corrosion inhibitor(s), dye(s), odorant(s), spreading agent(s), penetration aid(s), micronutrient(s), emollient(s), lubricant(s), sticking agent(s), dispersing agent(s), thickening agent(s), freezing point depressant(s), antimicrobial agent(s), or combinations thereof.

According to an embodiment, the liquid formulation further comprises an additional active ingredient selected from fungicides, insecticides, herbicides, plant regulators, defoliants, desiccants, biostimulants and nitrogen stabilizers, or combinations thereof.

According to an embodiment, the liquid formulation further comprises an additional herbicide.

According to an embodiment of the present invention, the additional herbicide is selected from the group comprising aliphatic acid herbicides, amide herbicides, aromatic acid herbicides, benzofuran herbicides, benzonitrile herbicides, benzophenone herbicides, benzothiadiazinone herbicides, benzyl ether herbicides, botanical herbicides, carbamate herbicides, cyclohexanedione oxime herbicides, dinitroaniline herbicides, dinitrophenol herbicides, diphenyl ether herbicides, diphenyl heterocyle herbicides, dithiocarbamate herbicides, fumigant herbicides, halogenated alkanoic acid herbicides, imidazolinone herbicides, inorganic herbicides, isoxazole herbicides, isoxazolidinone herbicides, isoxazoline herbicides, N-phenyl heterocycle herbicides, N-phenylimide herbicides, N-phenyloxadiazolone herbicides, N-phenyltriazolinone herbicides, organochlorine herbicides, organophosphorous herbicides, oxirane herbicides, oxyacetamide herbicides, phenol herbicides, phenoxy herbicides, phenylcarboxylic acid herbicides, phenyl ether herbicides, phenylthiourea herbicides, pyrazole herbicides, pyridazine herbicides, pyridazinone herbicides, pyridine herbicides, pyrimidinediamine herbicides, pyrimidinyloxybenzylamine herbicides, quaternary ammonium herbicides, quinone herbicides, alpha-thioacetamide herbicides, thiocarbamate herbicides, thiocarbonate herbicides, triazine herbicides, triazinone herbicides, triazole herbicides, triazolone herbicides, triazolopyrimidine herbicides, triketone herbicides, uracil herbicides, urea herbicides, unclassified herbicides, and combinations thereof.

In another embodiment, the additional herbicide is selected from the group comprising ACCase inhibitors, ALS inhibitors, EPSP synthase inhibitors, synthetic auxins, auxin transport inhibitors, HPPD inhibitors, lipid synthesis inhibitors, long chain fatty acid inhibitors, as well as herbicides with unknown modes of action, or combinations thereof.

In another embodiment, the formulation is used for controlling weeds at a locus.

In another embodiment, the present formulation prepared by the process of the present disclosure maybe used to target weeds such as Allium cepa, Ananas comosus, Arachis hypogaea, Asparagus officinalis, Avena sativa, Beta vulgaris spec altissima, Beta vulgaris spec rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Frag aria vesca, Glycine max, Gossypium hirsutum, (Gossypium arboreum, Gossy-pium herbaceum, Gossypium vitifolium), Helianthus annuus, Hevea brasiliensis, Hordeum vul-gare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Ni-cotiana tabacum (N. rustica), Olea europaea, Oryza sativa, Phaseoius iunatus, Phaseoius vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, So-lanum tuberosum, Sorghum bicolor (s. vulgare), Theobroma cacao, Trifolium pratense, Triticum aestivum, Triticale, Triticum durum, Vicia faba, Vitis vinifera, Zea mays.

In another embodiment, the present formulation prepared by the process of the present disclosure maybe used to target weeds among the crops such as rice, wheat, barley, rye, oat, sorghum, cotton, soybean, peanut, buckwheat, beet, rapeseed, sunflower, durum wheat, fall wheat, field corn, winter barley, cotton, fall barley, fallow, spring wheat, triticale, winter wheat, sugar cane, tobacco, etc.; vegetables; solanaceous vegetables such as eggplant, tomato, pimento, popper, potato, etc., cucurbit vegetables such as cucumber, pumpkin, zucchini, water melon, melon, squash, etc., cruciferous vegetables such as radish, white turnip, horseradish, kohlrabi, Chinese cabbage, cabbage, leaf mustard, broccoli, cauliflower, etc., asteraceous vegetables such as burdock, crown daisy, artichoke, lettuce, etc., liliaceous vegetables such as green onion, onion, garlic, and asparagus, ammiaceous vegetables such as carrot, parsley, celery, parsnip, etc., chenopodiaceous vegetables such as spinach, Swiss chard, etc., lamiaceous vegetables such as Perilla frutescens, mint, basil, etc. strawberry, sweet potato, Dioscorea japonica, colocasia, etc., flowers, foliage plants, turf grasses, fruits: pome fruits such apple, pear, quince, etc. stone fleshy fruits such as peach, plum, nectarine, Prunus mume, cherry fruit, apricot, prune, etc., citrus fruits such as orange, lemon, rime, grapefruit, etc., nuts such as chestnuts, walnuts, hazelnuts, almond, pistachio, cashew nuts, macadamia nuts, etc. berries such as blueberry, cranberry, blackberry, raspberry, etc., grape, kaki fruit, olive, plum, banana, coffee, date palm, coconuts, etc., trees otter than fruit trees; tea, mulberry, flowering plant, trees such as ash, birch, dogwood, Eucalyptus, Ginkgo biloba, lilac, maple, Quercus, poplar, Judas tree, liquidambar formosana, plane tree, zelkova. Japanese arborvitae, fir wood, hemlock, juniper, Pinus, Picea, and Taxus cuspidate, etc.

In another embodiment, the present invention provides a method of controlling weeds using a liquid formulation of L-glufosinate or its salt thereof.

In an embodiment, the method of controlling weeds comprises applying to a plant or a locus or a plant propagation material thereof, a herbicidally effective amount of a liquid formulation of L-glufosinate, salt of L-glufosinate, isomers, or combinations thereof.

In an embodiment, the method of controlling weeds comprises applying to a plant or a locus or a plant propagation material thereof, a herbicidally effective amount of a liquid formulation prepared by the process of the present invention.

An embodiment of the present invention provides a kit of parts comprising the liquid formulation prepared by the process of the present invention. Such kits may comprise, in addition to the present liquid formulation, one or more additional active and/or inactive ingredients and a user manual for using said formulation.

According to another embodiment, there is provided a liquid formulation of an ammonium salt of L-glufosinate, said formulation comprising:
a) an ammonium salt of L-glufosinate;
b) at least one organic solvent or at least one liquid surfactant; and
c) water;
wherein said ammonium salt of L-glufosinate is prepared by in-situ salification of L-glufosinate.

According to another embodiment, the liquid formulation of ammonium salt of L-glufosinate is obtained according to present invention.

According to an embodiment, the ammonium salt of glufosinate in the liquid formulation according to present invention is a racemic mixture of the D-glufosinate (about 50%) and the L-glufosinate (about 50%).

According to an embodiment, the ammonium salt of glufosinate in the liquid formulation according to present invention is in enantio-enriched form (more than about 50% L-glufosinate) or enantio-pure form (about 100% L-glufosinate).

According to another embodiment, the ammonium salt of glufosinate in the liquid formulation according to present invention comprises at least about 80% L-glufosinate and not more than 20% D-glufosinate.

According to another embodiment, the ammonium salt of glufosinate in the liquid formulation according to present invention comprises at least 90% L-glufosinate and not more than 10% D-glufosinate.

According to another embodiment, the ammonium salt of glufosinate in the liquid formulation according to present invention comprises at least 95% L-glufosinate and not more than 5% D-glufosinate.

In view of the above, it will be seen that the several advantages of the disclosure are achieved, and other advantageous results are attained. Although the present disclosure has been disclosed in full, it will be understood that numerous additional modifications and variations could be made thereto without departing from the scope of the disclosure. The embodiments may be combined together for better understanding of the disclosure, without departing from the scope of the disclosure.

In another embodiment, alternative or multiple embodiments of the disclosure disclosed herein are not to be construed as limitations. Each embodiment can be referred to and claimed individually or in any combination with other embodiments of the disclosure. One or more embodiments of the disclosure can be combined together to exhibit the teaching of the invention, without departing from the scope of the disclosure.

The following examples are presented to provide what is believed to be the most useful and readily understood description of procedures and conceptual aspects of this invention. The examples provided below are merely illustrative of the invention and are not intended to limit the same to disclosed embodiments. Variations and changes obvious to one skilled in the art are intended to be within the scope and nature of the invention.

### EXAMPLES

### Process for Preparation of a Liquid Formulation of Ammonium Salt of L-Glufosinate

Six formulations were prepared from Examples 1 to 6 by varying the ingredients as well as the amounts of the ingredients, using the following processes.

### Process for Examples 1 to 5

L-glufosinate, water, solvent, adjuvant/s or surfactant/s were mixed under agitation in a formulation vessel to get a dispersion. The dispersion thus obtained was heated to a temperature range from about 40° C. to about 60° C. Then, anhydrous ammonia gas was purged through the dispersion till the pH reached to a value from about 7 to about 9. Then, the mixture was stirred from about 30 minutes to about 45 minutes. The solution was stirred for another about 120 minutes to about 360 minutes at a temperature range from about 40° C. to about 60° C. to get a clear solution. The solution was then filtered and analysed to get final product, i.e., liquid formulation of ammonium salt of L-glufosinate.

### Process for Example 6

L-glufosinate, water and solvent were mixed under agitation in a formulation vessel to get a dispersion. The dispersion thus obtained was heated to a temperature range from about 40° C. to about 60° C. Then, anhydrous ammonia gas was purged through the dispersion till the pH reached to a value from about 7 to about 9. Then, the mixture was stirred from about 30 minutes to about 45 minutes. To the solution was then added adjuvant/s and surfactant/s under agitation. The solution was stirred for another about 120 minutes to about 360 minutes at a temperature range from about 40° C. to about 60° C. to get a clear solution. The solution was then filtered and analysed to get final product, i.e., liquid formulation of ammonium salt of L-glufosinate.
Example 1: A liquid formulation ammonium salt of L-glufosinate 280 SL
Example 2: A liquid formulation ammonium salt of L-glufosinate 280 SL
Example 3: A liquid formulation ammonium salt of L-glufosinate 200 SL
Example 4: A liquid formulation ammonium salt of L-glufosinate 150 SL
Example 5: A liquid formulation ammonium salt of L-glufosinate 200 SL
Example 6: A liquid formulation ammonium salt of L-glufosinate 150 SL

TABLE 1
Different formulations of ammonium salt of L-glufosinate

| | Exam- | Exam- | Exam- | Exam- | Exam- | Exam- |
|---|---|---|---|---|---|---|
| | ple | ple | ple | ple | ple | ple |
| Ingredients | 1 | 2 | 3 | 4 | 5 | 6 |
| L-glufosinate | 23.79 | 23.56 | 17.419 | 13.04 | 17.419 | 13.04 |
| Anhydrous | 2.25 | 2.27 | 1.646 | 1.23 | 1.646 | 1.23 |
| ammonia | | | | | | |
| Propylene | 17.00 | 10.00 | 17.00 | 17.00 | 22.00 | 20.00 |
| glycol | | | | | | |
| Butoxy | 7.00 | 2.00 | 7.00 | 5.50 | — | — |
| ethanol | | | | | | |
| Alkyl | — | — | — | 12.00 | — | 12.00 |
| glucamide | | | | | | |
| Alkyl | 11.00 | — | 11.00 | — | 11.00 | - |
| polyglucoside | | | | | | |
| Alkyl ether | 15.00 | — | 15.00 | 15.00 | 15.00 | 15.00 |
| phosphate | | | | | | |
| Alkyl amine | 15.00 | 46.00 | 15.00 | 15.00 | 15.00 | 15.00 |
| oxide | | | | | | |
| Adjuvant | 0.50 | 6.5 | 1.25 | 4.5 | 1.25 | 4.50 |
| Water | Q.S. | Q.S. | Q.S. | Q.S. | Q.S. | Q.S. |
| Total | 100 | 100 | 100 | 100 | 100 | 100 |

### Stability Study

Composition of Examples 1 to 2 were evaluated on the physico-chemical parameters for ambient temperature and 14 days, accelerated heat stability (AHS), and the results are disclosed in Table 2.

TABLE 2
Physico-chemical stability study

| | | | | | Stability |
|---|---|---|---|---|---|
| | Active content (% w/w) | | | Specific | at −5° C. |
| Example | | 14 days | | gravity | for 7 |
| No. | Ambient | AHS | pH | at 20° C. | days |
| 1 | 24.73 | 24.52 | 5.52 | 1.125 | Stable |
| 2 | 25.48 | 25.14 | 6.23 | 1.129 | Stable |

*Samples were tested as per the Collaborative International Pesticides Analytical Council (CIPAC) Miscellaneous Technique (MT) 46.3 method

It is evident from Table 2 that the liquid formulation of ammonium salt of L-glufosinate prepared according to the present invention, showed no degradation of active ingredient and was found to be stable in various assessment parameters.

What is claimed is:

1. A process for preparing a liquid formulation of an ammonium salt of glufosinate, or isomers thereof, said process comprising:
an in-situ salification of glufosinate.

2. The process as claimed in claim 1, wherein the glufosinate is selected from the group consisting of racemic glufosinate, L-glufosinate, D-glufosinate, a mixture of L-glufosinate and D-glufosinate, and combinations thereof;
wherein a weight ratio of the L-glufosinate to the D-glufosinate, when present, is in a range from about 1:99 to about 99:1.

3. The process as claimed in claim 1, wherein said process comprises:
a) suspending the glufosinate in a liquid medium to obtain a dispersion; and
b) salifying the dispersion of step a) with ammonia to obtain the liquid formulation of the ammonium salt of glufosinate.

4. The process as claimed in claim 3, wherein the liquid medium is selected from the group consisting of water, an organic solvent, a surfactant, and combinations thereof.

5. The process as claimed in claim 4, wherein the organic solvent is selected from the group consisting of vegetable oils and modified vegetable oils; glycols and their derivatives; esters; and combinations thereof.

6. The process as claimed in claim 5, wherein the organic solvent comprises glycols and their derivatives selected from the group consisting of propylene glycol, dipropylene glycol, polypropylene glycol, monoethylene glycol, diethylene glycol, polyethlene glycol 300, 1-methoxy-2-propanol, butoxy ethanol, and combinations thereof.

7. The process as claimed in claim 4, wherein the surfactant is selected from the group consisting of alcohol alkoxylate, alkyl ether phosphate, alkyl aryl ether phosphate, sulfosuccinate and its derivatives, and combinations thereof.

8. The process as claimed in claim 3, wherein step b) comprises heating the dispersion comprising the glufosinate in the liquid medium, to a temperature range from about 40° C. to about 100° C., and salifying the dispersion using ammonia.

9. A process for preparing a liquid formulation of an ammonium salt of L-glufosinate, said process comprising:
a) suspending L-glufosinate in a liquid medium to obtain a dispersion;
b) salifying the dispersion comprising the L-glufosinate in liquid medium of step a) with ammonia; and
c) subsequently, adding at least one surfactant or at least one adjuvant or a combination thereof to step b), to obtain the liquid formulation of the ammonium salt of glufosinate.

10. A process for preparing a liquid formulation of an ammonium salt of L-glufosinate, said process comprising:
a) suspending L-glufosinate in a liquid medium to obtain a dispersion;
b) adding at least one surfactant or at least one adjuvant, or combinations thereof to the dispersion; and
c) subsequently, salifying the dispersion with ammonia to obtain the liquid formulation of the ammonium salt of L-glufosinate.

11. A liquid formulation of an ammonium salt of L-glufosinate prepared by the process as claimed in claim 1, said formulation comprising:
a) an ammonium salt of L-glufosinate;
b) at least one organic solvent or at least one surfactant;
c) water; and
d) at least one agrochemically acceptable excipient.
